(19) United States
(12) Patent Application Publication
(10) Pub. No.: US 2019/0012474 A1
(43) Pub. Date: Jan. 10, 2019

(54) CONTROLLING ACCESS OF MEDIA ASSETS THROUGH A NETWORK

(71) Applicant: THOMSON Licensing, Issy-les-Moulineaux (FR)

(72) Inventors: Joel FOGELSON, Pasadena, CA (US); Samir AHMED, Culver City, CA (US)

(21) Appl. No.: 16/067,313

(22) PCT Filed: Dec. 31, 2015
(86) PCT No.: PCT/US2015/068290

§ 371 Date: Jun. 29, 2018

(51) Int. Cl. G06F 21/62; H04L 29/06; G06Q 50/00

(52) U.S. Cl. CPC G06F 21/6209; H04L 63/105; G06F 2221/2137; G06Q 50/01; G06F 2221/2113; H04L 63/108

(57) ABSTRACT

Access of media assets through a network is controlled. An expiration rule associated with a media asset is evaluated (930) utilizing at least one processing unit. Access of the media asset through the network is permitted (940-960), utilizing the at least one processing unit, based on the expiration rule within a first time period if an accessing user is classified in a first rank. Access of the media asset through the network is permitted (940-960), utilizing the at least one processing unit, based on the expiration rule within a second time period if the accessing user is classified in a second rank.

### TECHNICAL FIELD

Embodiments described herein relate generally to media assets and, more particularly, to controlling access of media assets based on rankings specified in expiration rules associated with the media assets.

### BACKGROUND

Users provide media assets for other users via a network in a variety of different ways. For example, user may provide media assets such as videos, images, texts, emails, social networking invites, social networking messages, tweets, and so on by submitting a post to a social media service such as Facebook™, Twitter™, Instagram™, Snapchat™, WhatsApp™, and so on. By way of another example, users may provide media assets to a media asset service such as YouTube™, M-Go™, Netflix™, Amazon Prime™, and so on. By way of still another example, user may provide media assets via a network delivery protocol such as texts and other messages via a mobile phone network, email, web pages, and so on.

Some mechanisms utilized by users to provide media assets for other users via a network automatically delete the media assets. For example, media assets shared through Snapchat are automatically deleted after being obtained.

### SUMMARY

Various embodiments described herein may relate to, include, or take the form of a method for controlling access of media assets through a network. Such a method may include evaluating an expiration rule associated with a media asset utilizing at least one processing unit, permitting access of the media asset through the network, utilizing the at least one processing unit, based on the expiration rule within a first time period if an accessing user is classified in a first rank, and permitting the access of the media asset through the network, utilizing the at least one processing unit, based on the expiration rule within a second time period if the accessing user is classified in a second rank.

In some implementations, the first time period is a first duration and the second time period is a second duration when the media asset is of a first media asset type and the first time period is a third duration and the second time period is a fourth duration when the media asset is of a second media asset type. In various implementations, the first time period and the second time period begin on at least one of a time when: the media asset was provided, specified by a user who provided the media asset, the accessing user first accesses the media asset, and the accessing user first utilizes a service that hosts the media asset after the media asset was provided.

### BRIEF DESCRIPTION OF THE FIGURES

Reference will now be made to representative embodiments illustrated in the accompanying figures. It is understood that the following descriptions are not intended to limit the disclosure a particular embodiment or a set of particular embodiments. To the contrary, this disclosure is intended to cover alternatives, modifications, and equivalents as may be included within the spirit and scope of the described embodiments as defined by the appended claims and as illustrated in the accompanying figures:

FIG. 1 depicts an example of a system for controlling access of media assets through a network;

FIG. 2 depicts a block diagram of examples of components and functional relationships of components that may be used in the server computing device of FIG. 1;

FIG. 3 depicts an example of metadata specifying expiration rules including rankings for different types of media assets;

FIG. 4 depicts an example of metadata specifying an expiration rule including rankings for a media asset;

FIG. 5 depicts an example of a user interface for specifying expiration time periods associated with different rankings for different types of media assets;

FIG. 6 depicts an example of providing a media asset via a social media network post that includes an interface for specifying expiration time periods associated with different rankings;

FIG. 7 depicts an example of a user interface for classifying users into different rankings;

FIG. 8 depicts an example of metadata specifying classification of users into rankings;

FIG. 9 depicts a flow chart illustrating operations of an example of a method for controlling access of media assets through a network; and

FIG. 10 depicts a flow chart illustrating operations of an example of a method for providing access to media assets through a network according to at least one expiration rule.

The use of the same or similar reference numerals in different drawings indicates similar, related, or identical items.

### DESCRIPTION OF THE EMBODIMENTS

Many embodiments described herein relate to methods, systems, and computer program products for controlling access to media assets through a network. Users may be permitted to access media assets if a time period has not expired. The time period depends on the user's rank. The time period is a first time period if the rank is a first rank, a second time period if the rank is a second rank, and so on. This may provide flexibility for provided media assets beyond situations where media assets expire after a single time period.

Time periods and associated ranks may be specified in expiration rules associated with media assets. Such expiration rules may be configured according to a variety of different parties. Expiration rules may be specified individually, in groups according to media types, and so on. The time periods may begin at various times.

Accessing users may be classified based on any or all of a relationship to other users, a utilized service, a ranked list (such as a contact list), and so on. Ranking classification (as well as expiration rules) may be applied by various default settings. Such default settings may be overridden by various parties.

In some implementations, an accessing user may not be provided with an indication that the media asset exists if the relevant time period associated has expired. In various implementations, the media asset may be delete when time periods for all rankings have expired.

In various implementations, the time periods may be extendable. Time periods may be extended based on relevance of the media asset, receipt of a request to extend, the number of media assets available, popularity of the media asset and the providing, utilization of a service after the time period expired, and so on.

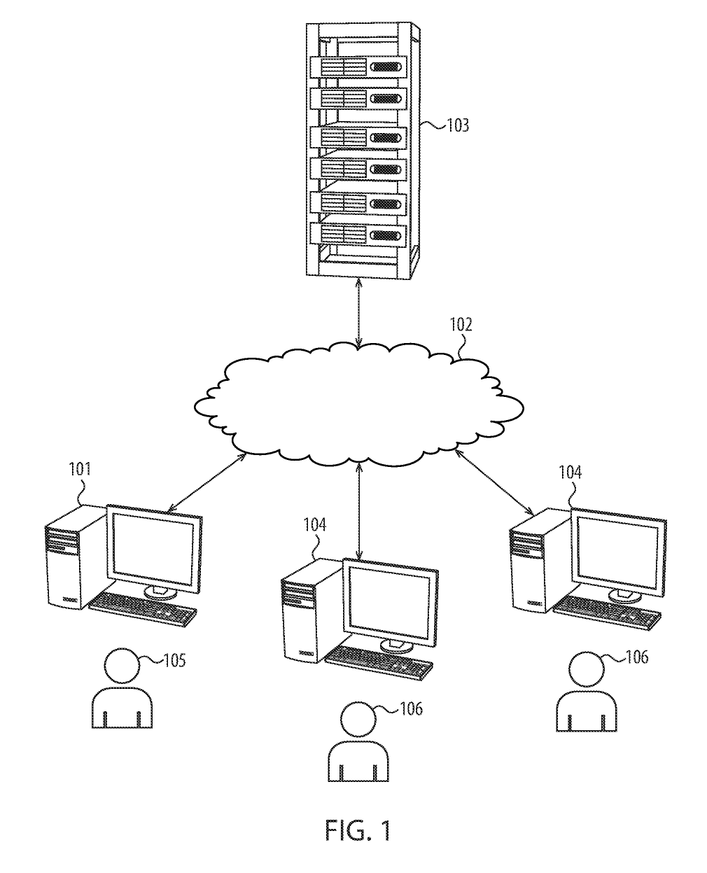

FIG. 1 depicts an example of a system 100 for controlling access of media assets through a network. The system 100 may include a number of computing devices such as a provider computing device 101, a server computing device 103, and a number of client computing devices 104 that are connected by a network 102. A provider 105 (a providing user) may provide media assets using the provider computing device 101. A number of receivers 106 (accessing users) may obtain provided media assets via the client devices 104. The server computing device 103 may enable such sharing of media assets. The server computing device 103 may be a component of a social media service, a media asset service, a network delivery protocol implementation, and so on.

The system 100 may evaluate an expiration rule associated with a media asset. The system 100 may permit access of the media asset through the network 102 based on the expiration rule within a time period associated with a rank according to which an receiver 106 is classified. The time period may be a first time period if the receiver 106 is classified in a first rank, a second time period if the receiver 106 is classified in a second rank, and so on.

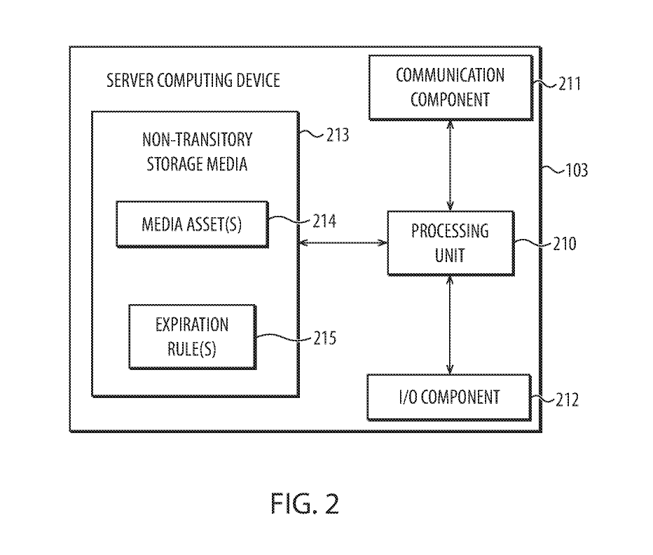

In various embodiments, the server computing device 103 may receive requests from the client devices 104 and provide media assets according to expiration rules associated with the media assets. FIG. 2 depicts a block diagram of examples of components and functional relationships of components that may be used in the server computing device 103 of FIG. 1. As illustrated, the may include one or more processing units 210, input/output components 212, communication components 211, and non-transitory storage media 311 (which may take the form of, but is not limited to, a magnetic storage medium, optical storage medium, magneto-optical storage medium, read only memory, random access memory, erasable programmable memory, flash memory, and so on), and so on. The processing unit 210 may execute instructions stored in the non-transitory storage media 213 to perform various functions.

For example, execution of such instructions may cause the processing unit 210 to evaluate an expiration rule 215 associated with a media asset 214. Execution of such instructions may further configure the processing unit 210 to permit access based on the expiration rule 215 within a first time period if an accessing user is classified in a first rank, permit access based on the expiration rule 215 within a second time period if an accessing user is classified in a second rank, and so on.

Returning to FIG. 1, in other embodiments, the system 100 may be configured in other ways than illustrated and described with respect to FIG. 2. For example, the system 100 may be configured such that the provider computing device 101 performs the above functions; a client computing device 104 performs the above functions; a combination of the provider computing device 101 and the server computing device 103 cooperatively performs the above functions; a combination of the provider computing device 101 and a client computing device 104 cooperatively performs the above functions; and so on. Further, the server computing device 103 may be multiple server computing devices 103 in various embodiments. For example, media assets may be stored by a storage server that supplies media assets upon instruction by an authorization server according to expiration rules, an authorization server may retrieve and provide media assets stored by a storage server based on expiration rules, and so on.

Expiration rules may be associated with individual media assets, types of media assets (which may be different for assets of a first media asset type such as images and a second media asset type such as videos), and so on. For example, a first series of ranks and associated time periods may be associated with image files whereas a second series of ranks and associated time periods may be associated with video files.

Expiration rules may be configured according to the provider 105, a receiver 106, and so on. Expiration rules may be configured in response to a specific direction from a user, based on default settings, and so on. In situations where expiration rules are configured based on defaults settings, a user may be allowed to override the defaults.

For example, expiration rules may be configured for or by the provider 105 of the media asset. This may allow the provider 105 to control the availability of the media asset, manage storage space used by their media content, and so on.

By way of another example, expiration rules may be configured for the receiver 106. This may allow the receiver 106 to filter browsing of media assets in order to find media assets to access, control storage space used for media assets, control network resources used for media assets, and so on.

Time periods associated with expiration rules may be handled in a variety of different ways. Time periods may begin when the provider 105 of the media asset provides the media asset, the provider 105 specifies, the receiver 106 first accesses the media asset, the receiver 106 first utilizes a service that hosts the media asset after the media asset is provided, and so on.

Receivers 106 be classified into different ranks based on a variety of different criteria. In some implementations, receivers 106 may be classified into a rank based on a relationship between the receiver 106 and the provider 105 of the media asset on a service, such as services (such as social media services) that allow access (such as by hosting) the media asset.

For example, a social media service may allow provider 105 to “friend” (e.g., link to) other users. As such, receivers 106 may be ranked as friends and others (e.g., “not friends”). The social media service may also allow providing users 105 to designate friends as “close friends” to indicate a closer relationship than other friends. As such, receivers 106 who are friends of the providing users 105 may be ranked as close friends and friends. Such a configuration allows for at least three rankings of receivers 106.

By way of another example, various services may allow providing users 105 to rank other users in a variety of different ranks (such as three, five, and so on) based on the strength of their association. Such ranking may be explicitly be specified by a user, automatically derived at least based on interactions between users, configured by defaults that may be overridden by users, and so on.

By way of a third example, a service may rank receivers 106 for the provider 105 based on a contact list for the provider 105. The provider 105 may configure a variety of groupings into which entries of the contact list may be classified (such as friends, family, close friends, close family, business contacts, co-workers, potential business contacts, and so on) and rankings may be derived from such groupings.

In some embodiments, a media asset may be automatically deleted when all time periods specified in associated expiration rules have elapsed. In this way, storage space may be made available for other media assets, an overabundance of media assets may be prevented, and so on.

In various embodiments, a user interface may be presented to the receiver 106 indicating media assets that the receiver 106 may then request. In such a configuration, indicating a media asset in such a user interface may confirm that the media asset exists. If the time period has elapsed for the media asset specified in the expiration rule for a rank that the receiver 106 is classified into, confirmation that the media asset exists may be omitted. For example, that media asset may not be indicated in such a user interface.

In numerous embodiments, a time period specified in the expiration rule for a rank that the receiver 106 is classified into may be extended. The time period may be extended based upon a variety of different factors such as relevance of the media asset to the receiver 106, receipt of a request to extend from the receiver 106, the media assets available to the receiver 106 exceed a threshold (such as more than two hundred), a popularity (such as of the media asset, the provider 105, the receiver 106, and so on), a service that provides the media asset has not been utilized by the receiver 106 since the asset was provided, and so on. Extending the time period may provide an increased chance that the receiver 106 will have adequate time to obtain the media asset while balancing concerns favoring expiration.

In such embodiments, the expiration rules may indicate if a time period may be extended. Control of extensions may be specified by the provider 105, the receiver 106, and so on. Extensions may be available for a portion of the rankings.

Expiration rules may be implemented in a variety of ways. In some embodiments, expiration rules may be implemented as metadata that is included in media assets, associated with media assets, and so on.

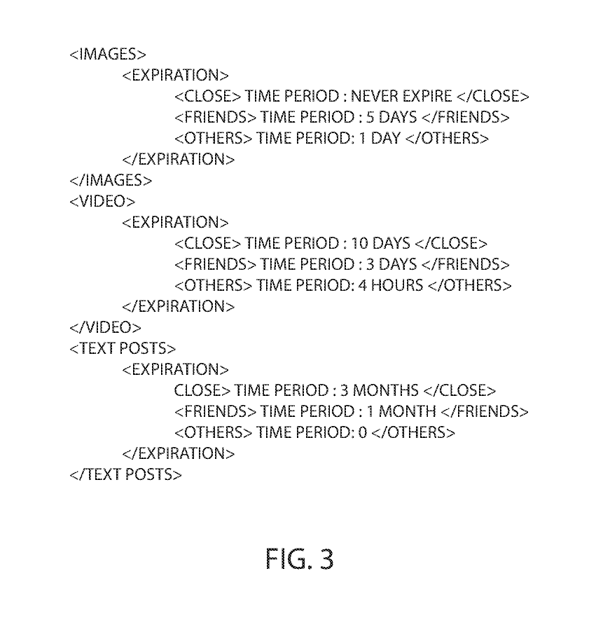

For example, FIG. 3 depicts an example of metadata specifying expiration rules including rankings for different types of media assets. As shown, separate expiration rules are included for images, video, and text posts. Each expiration rule includes a time period for accessing users of a “close” rank, a “friends” rank, and an “others” rank. In this metadata specifying expiration rules, the time period for images for the close rank is never expire (effectively an infinite time period so close accessing users may obtain image media assets indefinitely), of the friends rank is five days, and of the others rank is 1 day. Further, the time period for videos for the close rank is ten days, of the friends rank is three days, and of the others rank is four hours. Additionally, the time period for text posts for the close rank is three months, of the friends rank is one month, and of the others rank is zero (effectively barring accessing users of the other rank from obtaining any text posts as they expire immediately).

This metadata may function as defaults according to which expiration rules for individual media assets are determined. In some implementations, the expiration rules specified in this metadata may be applied to individual media assets when they are provided. In various implementations, such defaults may be overridden.

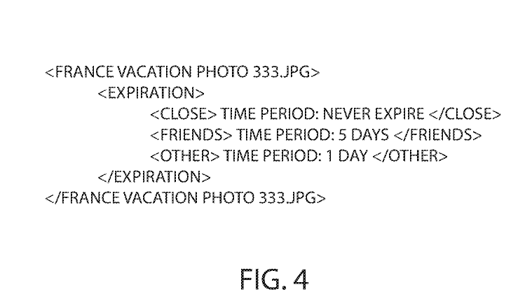

By way of another example, FIG. 4 depicts an example of metadata specifying an expiration rule including rankings for a media asset. As illustrated, the media asset is a JPG file with a title “FRANCE VACATION PHOTO 333.” The file has an associated time period of never expire for the close rank, five days for the friends rank, and one day for the other rank.

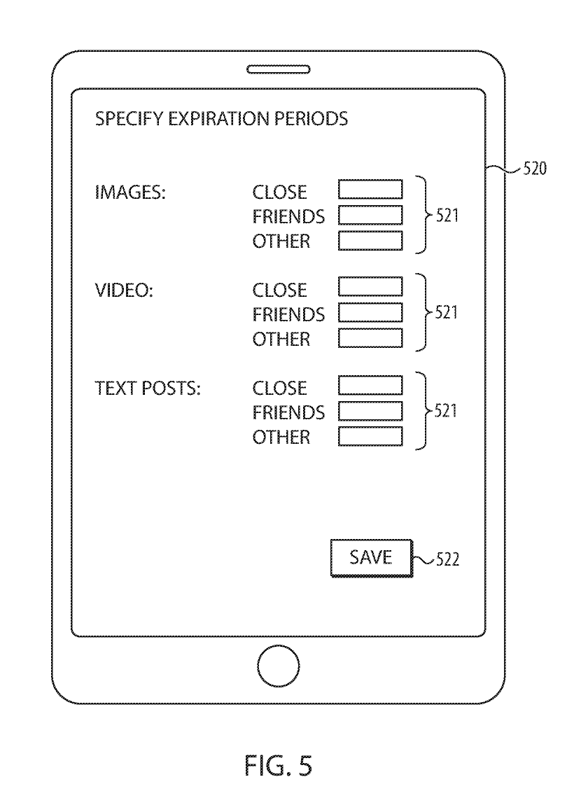

FIG. 5 depicts an example of a user interface 520 for specifying expiration time periods associated with different rankings for different types of media assets. As shown, the user interface 520 includes blanks 521 for entry of separate time periods for close, friends, and other rankings for images, video, and text posts. As also illustrated, this user interface 520 includes a save button 522 that can be selected to save the entered time periods. Such a user interface 520 may be used to create metadata such as the metadata of FIG. 3.

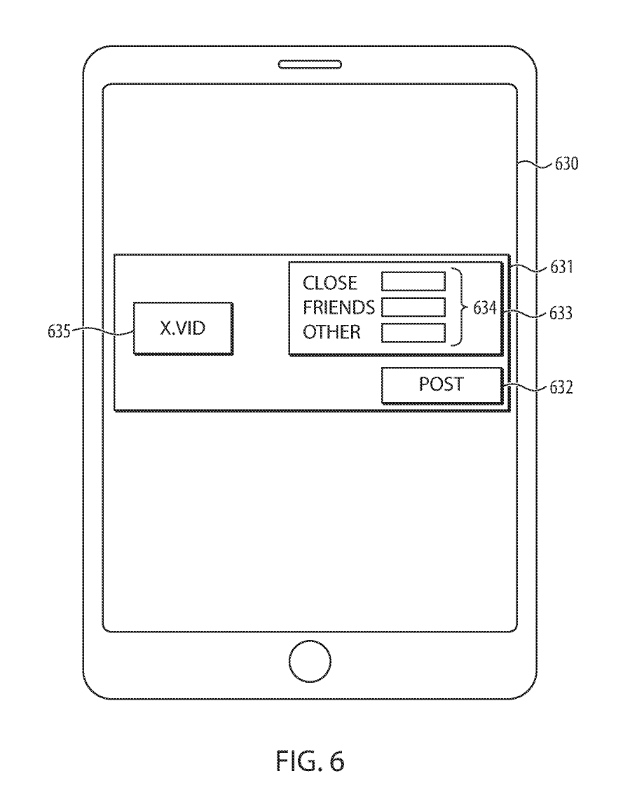

FIG. 6 depicts an example of providing a media asset 633 via a social media network post 631 that includes an interface 633 for specifying expiration time periods 634 associated with different rankings. As shown, the social media network post 631 is configured to post the X.VID 635 video file. The interface 633 includes a number of blanks into which values can be entered for specifying expiration time periods 634 associated with close, friends, and other ranks. A post button 632 is included that may be selected to post the X.VID 635 video file with any time periods entered applied. Such a social media network post 631 interface may be used to create metadata such as the metadata of FIG. 4.

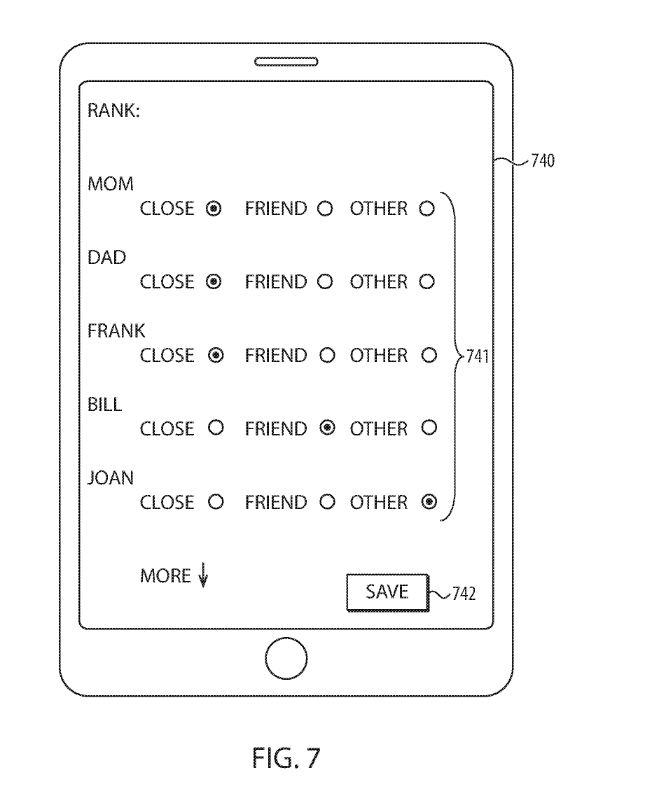

FIG. 7 depicts an example of a user interface 740 for classifying users into different rankings. As shown, the user interface 740 includes radio buttons 741 for different users in a list that can be selected to classify the users in the close, friend, and other ranks. As also illustrated, this user interface 740 includes a save button 742 that can be selected to save the selected rankings.

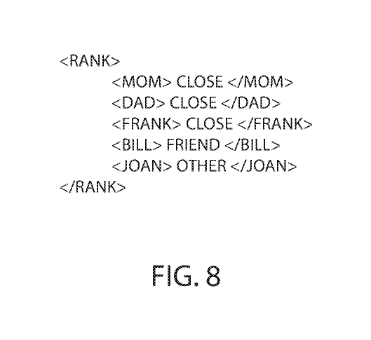

FIG. 8 depicts an example of metadata specifying classification of users into rankings. As shown, users “MOM,” “DAD,” and “FRANK” are classified in the close rank. As also shown, user “BILL” is classified in the friend rank and user “JOAN” is classified in the other rank. This metadata may be created by a user interface such as the user interface 740 of FIG. 7.

FIGS. 3-8 use an example of a ranking system including close, friends, and other ranks. In various implementations, any kinds of ranking systems may be used. For example, in some implementations, a ranking system may classify users into ranks such as very important, important, normal, and unimportant. By way of another example, in various implementations, a ranking system may classify users into numerical rankings. By way of still another example, in numerous implementations, a ranking system may classify users into ranks such as coworkers, clients, potential clients, personal, and unknown.

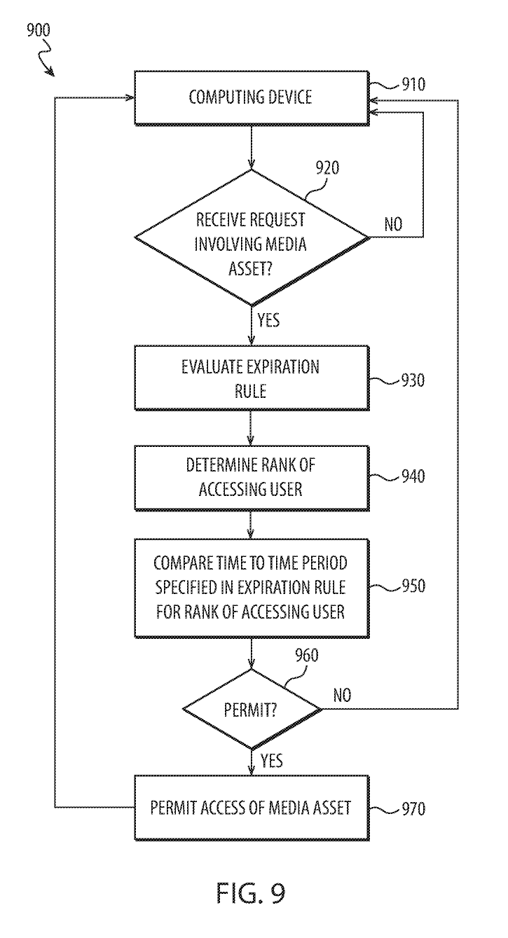

FIG. 9 depicts a flow chart illustrating operations of an example of a method 900 for controlling access of media assets through a network. The method 900 may be performed by a device such as the server computing device 103 of FIGS. 1 and 2, the provider computing device 101 of FIG. 1, the client computing device 104 of FIG. 1, and so on.

At 910, a computing device operates. The flow proceeds to 920 where the computing device determines whether or not a request is received involving a media asset. Such a request may be a request to indicate available media assets, a request to access a media asset, and so on. If so, the flow proceeds to 930. Otherwise, the flow returns to 910 where the computing device continues to operate.

At 930, after the computing device determines a request is received involving a media asset, an expiration rule is evaluated. Then, at 940, the computing device determines a rank of the accessing user. The flow then proceeds to 950 where the computing device compares a time to a time period specified in the expiration rule for the determined rank. Next, the flow proceeds to 960.

At 960, the computing device determines whether or not to permit the request based on the comparison of the time to the time period specified in the expiration rule for the determined. For example, the request may be permitted if the time is within the time period and not permitted if the time period is outside the time period.

If not, the flow returns to 910 where the computing device continues to operate. Otherwise, the flow proceeds to 970 where access of the media asset is permitted before the flow returns to 910 where the computing device continues to operate.

Although the method 900 is illustrated and described above as including particular operations performed in a particular order, it is understood that this is an example. In various implementations, various orders of the same, similar, and/or different operations may be performed without departing from the scope of the present disclosure.

For example, 930-950 are illustrated and described as separate, linearly performed operations. In various embodiments, 930-950 may be performed simultaneously.

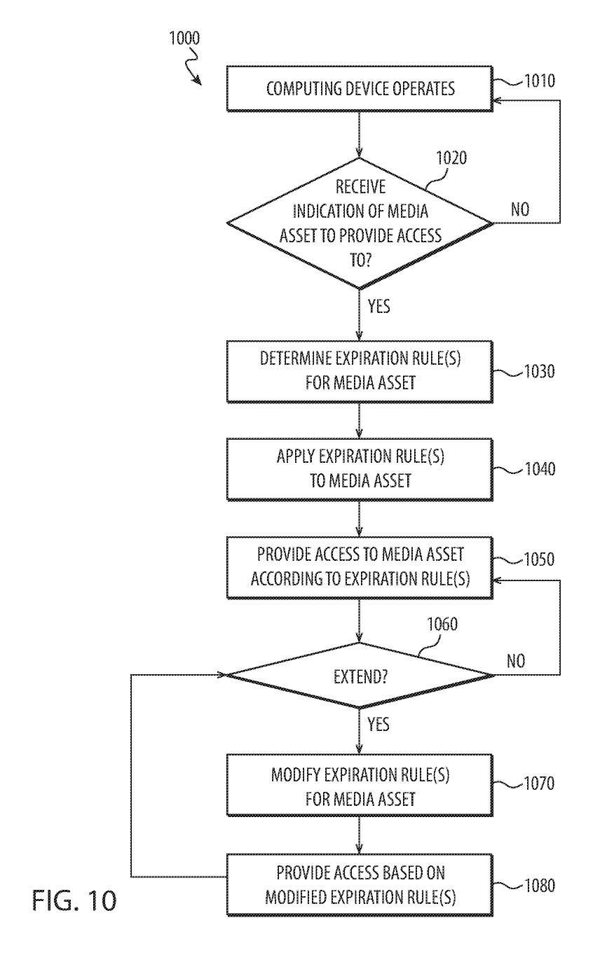

FIG. 10 depicts a flow chart illustrating operations of an example of a method 1000 for providing access to media assets through a network according to at least one expiration rule. The method 1000 may be performed by a device such as the server computing device 103 of FIGS. 1 and 2, the provider computing device 101 of FIG. 1, the client computing device 104 of FIG. 1, and so on.

At 1010, a computing device operates. The flow proceeds to 1020 where the computing device determines whether or not an indication of a media asset to provide is received. If so, the flow proceeds to 1030. Otherwise, the flow returns to 1010 where the computing device continues to operate.

At 1030, after the computing device determines an indication of a media asset to provide is received, the computing device determines at least one expiration rule for the media asset. The flow then proceeds to 1040 where the computing device applies the expiration rule to the media asset. Next, the flow proceeds to 1050 where the computing device provides the media asset according to the expiration rules.

The flow then proceeds to 1060 where the computing device determines whether or not to extend a time period specified in the expiration rules. If not, the flow returns to 1050 where the computing device continues to provide the media asset according to the expiration rule. Otherwise, the flow proceeds to 1070.

At 1070, after the computing device determines to extend a time period specified in the expiration rules, the computing device modifies the expiration rule for the media asset. The flow then proceeds to 1080 where the computing device provides access to the media asset based on the modified expiration rules. Next, the flow returns to 1060 where the computing device determines whether or not to extend a time period specified in the expiration rules.

Although the method 1000 is illustrated and described above as including particular operations performed in a particular order, it is understood that this is an example. In various implementations, various orders of the same, similar, and/or different operations may be performed without departing from the scope of the present disclosure.

For example, 1060-1080 illustrate and describe extending time periods. In some implementations, time periods may not be extendable.

As described above and illustrated in the accompanying figures, the present disclosure details embodiments related to methods, systems, and computer program products for controlling access to media assets through a network. Users may be permitted to access media assets if a time period has not expired. The time period depends on the user's rank. The time period is a first time period if the rank is a first rank, a second time period if the rank is a second rank, and so on. This may provide flexibility for provided media assets beyond situations where media assets expire after a single time period.

Various embodiments described herein may relate to, include, or take the form of a method for controlling access of media assets through a network. Such a method may include evaluating an expiration rule associated with a media asset utilizing at least one processing unit, permitting access of the media asset through the network, utilizing the at least one processing unit, based on the expiration rule within a first time period if an accessing user is classified in a first rank, and permitting the access of the media asset through the network, utilizing the at least one processing unit, based on the expiration rule within a second time period if the accessing user is classified in a second rank.

In some implementations, the first time period is a first duration and the second time period is a second duration when the media asset is of a first media asset type and the first time period is a third duration and the second time period is a fourth duration when the media asset is of a second media asset type. In various implementations, the first time period and the second time period begin on at least one of a time when: the media asset was provided, specified by a user who provided the media asset, the accessing user first accesses the media asset, and the accessing user first utilizes a service that hosts the media asset after the media asset was provided.

In numerous implementations, the method further includes configuring the expiration rule according to a providing user of the media asset. In various implementations, the method further includes configuring the expiration rule according to the accessing user. In some implementations, the method further includes deleting the media asset after all time periods specified in the expiration rule have elapsed. In various implementations, the method further includes omitting confirmation of existence of the media asset through the network based on the expiration rule if the first time period has elapsed and the accessing user is classified in the first rank. In numerous implementations, the method further includes extending the first period based on at least one of relevance of the media asset to the accessing user, receipt of a request to extend from the accessing user, media assets available to the accessing user exceed a threshold, a popularity of at least one of the media asset and a user who provided the media asset, and the accessing user has not utilized a service that hosts the media asset since the media asset was provided.

In various implementations, classification of the accessing user is at least one of configured according to a providing user of the media asset and based on a relationship between the accessing user and the providing user of the media asset on a service that hosts the media asset. In some implementations, the expiration rule is associated with the media asset by default. In such implementations, the method may further include allowing a user to override the default for the media asset.

Some embodiments described herein may relate to, include, or take the form of a computing device. Such a computing device may include a processing unit and a memory coupled to the processing unit. The memory may store instructions. The instructions, when executed by the processing unit, may configure the processing unit to determine whether to permit access of a media asset through a network based on an expiration rule associated with a media asset and permit access within a first time period if an accessing user is classified in a first rank and within a second time period if the accessing user is classified in a second rank.

In various implementations, the expiration rule is included in metadata that is associated with the media asset. In some examples of such implementations, the metadata is included in the media asset.

In some implementations, the processing unit is configured to transmit the media asset to the accessing user if the access is permitted. In various implementations, the processing unit determines whether to permit access by determining a current time and evaluating the expiration rule based on the current time.

Numerous embodiments described herein may relate to, include, or take the form of a computer program product. Such a computer program product may be embodied in a non-transitory storage medium. The computer program product may include a first set of instructions, stored in the non-transitory storage medium, executable by a processing unit to determine to permit access of a media asset through a network based on an associated expiration rule within a first time period if an accessing user is classified in a first rank. The computer program product may also include a second set of instructions, stored in the non-transitory storage medium, executable by the processing unit to determine to permit access of the media asset through the network based on the associated expiration rule within a second time period if an accessing user is classified in a second rank. In some examples, the first time period is longer than the second time period.

In various examples, the computer program product may include a third set of instructions, stored in the non-transitory storage medium, executable by the processing unit to determine to not permit access of the media asset through the network based on the associated expiration rule because the accessing user is classified in a third rank and the expiration rule includes a zero time period associated with the third rank. In other examples, the computer program product may include a third set of instructions, stored in the non-transitory storage medium, executable by the processing unit to determine to not permit access of the media asset through the network based on the associated expiration rule within a second time period if an accessing user is classified in a second rank. In still other examples, the computer program product may include a third set of instructions, stored in the non-transitory storage medium, executable by the processing unit to determine to permit access of the media asset through the network based on the associated expiration rule because the accessing user is classified in a third rank and the expiration rule includes an indefinite period associated with the third rank.

Various embodiments described above with reference to the accompanying drawings, which form a part hereof, and which show specific illustrative embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. The foregoing detailed description is, therefore, not to be taken in a limiting sense.

In the present disclosure, the methods disclosed may be implemented as sets of instructions or software readable by a device. Further, it is understood that the specific order or hierarchy of operations in the methods disclosed are examples of sample approaches. In other embodiments, the specific order or hierarchy of operations in the method can be rearranged while remaining within the disclosed subject matter. The accompanying method claims present elements of the various operations in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The use of “and/or” and “at least one of” (for example, in the cases of “A and/or B” and “at least one of A and B”) is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as listed.

Although embodiments which incorporate the teachings of the present disclosure have been shown and described in detail herein, those skilled in the art can readily devise many other varied embodiments that still incorporate these teachings. Having described preferred embodiments of a system, method and user interface for content search (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method for controlling access of media assets through a network, the method comprising:
permitting access of a media asset through the network, utilizing a processing unit, based on an expiration rule within a first time period if an accessing user is classified in a first rank; and
permitting the access of the media asset through the network, utilizing the processing unit, based on the expiration rule within a second time period if the accessing user is classified in a second rank.

2-4. (canceled)

5. The method of claim 1, wherein classification of the accessing user is at least one of:
configured according to a providing user of the media asset; and based on a relationship between the accessing user and the providing user of the media asset on a service that hosts the media asset.

6. The method of claim 1, wherein the expiration rule is associated with the media asset by default, the method further including:
allowing a user to override the default for the media asset.

7. The method of claim 1, wherein the method further includes:
configuring the expiration rule according to the accessing user.

8. The method of claim 1, wherein the method further includes:
deleting the media asset after all time periods specified in the expiration rule have elapsed.

9. The method of claim 1, wherein the method further includes:
omitting confirmation of existence of the media asset through the network based on the expiration rule if the first time period has elapsed and the accessing user is classified in the first rank.

10. The method of claim 1, wherein the method further includes:
extending the first period based on at least one of:
relevance of the media asset to the accessing user;
receipt of a request to extend from the accessing user;
media assets available to the accessing user exceed a threshold;
a popularity of at least one of the media asset and a user who provided the media asset; and
the accessing user has not utilized a service that hosts the media asset since the media asset was provided.

11. A computing device comprising:
a processing unit; and
a memory, coupled to the processing unit, storing instructions which, when executed by the processing unit, configures the processing unit to:
determine whether to permit access of a media asset through a network based on an expiration rule associated with a media asset; and
permit access within a first time period if an accessing user is classified in a first rank and within a second time period if the accessing user is classified in a second rank.

12. The computing device of claim 11, wherein:
the first time period is a first duration and the second time period is a second duration when the media asset is of a first media asset type; and
the first time period is a third duration and the second time period is a fourth duration when the media asset is of a second media asset type.

13. The computing device of claim 11, wherein the instructions further configure the processor to:
configure the expiration rule according to a providing user of the media asset.

14. The computing device of claim 11, wherein the first time period and the second time period begin on at least one of a time when:
the media asset was provided;
specified by a user who provided the media asset;
the accessing user first accesses the media asset; and
the accessing user first utilizes a service that hosts the media asset after the media asset was provided.

15-17. (canceled)

18. The computing device of claim 11, wherein the instructions further configure the processor to:
delete the media asset after all time periods specified in the expiration rule have elapsed.

19. The computing device of claim 11, wherein the instructions further configure the processor to:
omit confirmation of existence of the media asset through the network based on the expiration rule if the first time period has elapsed and the accessing user is classified in the first rank.

20. The computing device of claim 11, wherein the instructions further configure the processor to:
extend the first period based on at least one of:
relevance of the media asset to the accessing user;
receipt of a request to extend from the accessing user;
media assets available to the accessing user exceed a threshold;
a popularity of at least one of the media asset and a user who provided the media asset; and the accessing user has not utilized a service that hosts the media asset since the media asset was provided.

21. A non-transitory computer-readable medium storing computer-executable program instructions executable to perform a method for controlling access of media assets through a network, the method comprising:
permitting access of a media asset through the network, utilizing a processing unit, based on an expiration rule within a first time period if an accessing user is classified in a first rank; and
permitting the access of the media asset through the network, utilizing the processing unit, based on the expiration rule within a second time period if the accessing user is classified in a second rank.

22. The method of claim 21, wherein:
the first time period is a first duration and the second time period is a second duration when the media asset is of a first media asset type; and
the first time period is a third duration and the second time period is a fourth duration when the media asset is of a second media asset type.

23. The method of claim 21, wherein the method further includes:
configuring the expiration rule according to a providing user of the media asset.

24. The method of claim 21, wherein the first time period and the second time period begin on at least one of a time when:
the media asset was provided;
specified by a user who provided the media asset;
the accessing user first accesses the media asset; and
the accessing user first utilizes a service that hosts the media asset after the media asset was provided.

25. The method of claim 21, wherein classification of the accessing user is at least one of:
configured according to a providing user of the media asset; and
based on a relationship between the accessing user and the providing user of the media asset on a service that hosts the media asset.

26. The method of claim 21, wherein the expiration rule is associated with the media asset by default, the method further including:
allowing a user to override the default for the media asset.

27-30. (canceled)
